(19) United States
(12) Patent Application Publication
(10) Pub. No.: US 2016/0164195 A1
(43) Pub. Date: Jun. 9, 2016

(54) CONTACT ELEMENT AND METHOD FOR PRODUCING A CONTACT ELEMENT

(71) Applicant: BIOTRONIK SE & Co. KG, Berlin (DE)

(72) Inventors: Marcel Starke, Eichwalde (DE); Martin Bohmeyer, Neuenhagen (DE); Ringo Mannhaupt, Luckenwalde (DE); Ronald Rebentisch, Berlin (DE); Torsten Oertmann, Blankenfelde (DE)

(21) Appl. No.: 14/938,539

(22) Filed: Nov. 11, 2015

Related U.S. Application Data
(60) Provisional application No. 62/087,269, filed on Dec. 4, 2014.

(51) Int. Cl. H01R 4/48; H01R 43/16

(52) U.S. Cl. CPC H01R 4/48; H01R 43/16; H01R 2201/12

(57) ABSTRACT

A spring sleeve for an electrical contact element, in particular for a medical implant, including a connector bore for receiving an electrical mating contact in an insertion direction; at least one spring accommodating region, which is disposed around the connector bore, at least in regions, and is open, at least in regions, toward the connector bore, said spring accommodating region being provided to receive a spring element for the electrical contacting of the electrical mating contact, wherein an open space is provided in the spring accommodating region such that a properly inserted spring element can deflect into the open space when the mating contact is inserted. Furthermore, an electrical contact element comprising a spring sleeve is proposed, as well as a method for producing a contact element.

### CROSS-REFERENCE TO RELATED APPLICATIONS

This patent application claims the benefit of co-pending U.S. Provisional Patent Application No. 62/087,269, filed on Dec. 4, 2014, which is hereby incorporated by reference in its entirety.

### TECHNICAL FIELD

The present invention relates to an electrical contact element and a method for producing an electrical contact element at least according to the preambles of the independent claim(s).

### BACKGROUND

Medical implants, in particular active implantable medical devices, that can be introduced into the human or animal body and require an electrical supply voltage, must have particularly safe and permanent electrical contacting. Such implants are, for example, cardiac pacemakers, defibrillators, neurostimulators, and the like.

Document European Patent No. 2 614 856 discloses a contact device having a contact element and a mating contact, which is inserted into a connector bore of the contact element. Wire spirals disposed in the contact element then come into contact with electrical contact surfaces of the mating contact. The wire spirals act on the contact surfaces in a radial direction and are supported radially outward in corresponding exact-fit recesses in the contact element.

Document German Patent No. 690 27 846 makes known an electrical contact element for medical implants that can be introduced into the human or animal body, in which an electrical connection is established by means of a toroidal spring and a pin of a plug contact. The toroidal spring is inserted into a groove of a socket, wherein the electrical contact is established between the pin and the inner circumference of the toroidal spring.

The production of toroidal springs, in particular closed toroidal springs, and the installation thereof by insertion into the circumferential groove of corresponding spring sleeves is complex and difficult to automate and, therefore, is correspondingly cost-intensive.

A problem addressed by the present invention is that of creating a spring sleeve for an electrical contact element that can be produced in an at least largely automated manner.

Another problem addressed by the present invention is that of creating an electrical contact element that can be produced in an at least largely automated manner.

In addition, a method shall be created for producing such a contact element.

At least the above problems are solved according to the present invention by the features of the independent claim(s). Favorable embodiments and advantages of the present invention will become apparent from the further claims, the description, and the drawings.

The present invention is directed toward overcoming one or more of the above-mentioned problems.

### SUMMARY

According to one aspect of the present invention, a spring sleeve for an electrical contact element is proposed, in particular for a medical implant, comprising:
a connector bore for receiving an electrical mating contact in an insertion direction; and
at least one spring accommodating region, which is disposed around the connector bore, at least in regions, and is open, at least in regions, toward the connector bore, said spring accommodating region being provided to receive a spring element for the electrical contacting of the electrical mating contact. At least one open space is provided in the spring accommodating region such that a properly inserted spring element can deflect into the open space when the mating contact is inserted.

Medical implants within the meaning of the present invention are, in particular, active implantable medical devices, for example, cardiac pacemakers, electrical neurostimulators, and the like.

Advantageously, the spring sleeve can be produced with greater tolerances than is the case with an exclusively radially acting spring according to the prior art, since, when the spring element is inserted, the spring accommodating region does not need to support the spring element in a radially outward direction. As a result, low-cost production processes can be used for the spring sleeve, such as, for example, primary-shaping sinter processes. The contact force of the spring element is not achieved by means of the radial preload between the mating contact, the spring element, and the spring sleeve, but rather can be achieved by generating a tensile stress in the spring element.

According to a favorable embodiment, the spring accommodating region can be substantially U-shaped in design, having a curved section and channels extending away from the curved section. This permits favorable production of the spring sleeve and a spring element to be inserted, wherein said spring element can be designed as a tensile loop. In this regard, the curved section encloses the connector bore, at least in regions, and has an open space disposed radially outward for the spring element. The channels extending away therefrom can be used to affix the spring element. The channels can be open toward the outside such that, when the spring element is inserted, the spring element can be fixed and/or electrically contacted.

As an alternative, the spring accommodating region can be designed such that it can accommodate two or more spring element pieces, for example, parallel pieces, intersecting pieces, or the like.

According to a favorable embodiment, the spring sleeve can be designed to comprise at least two parts, namely, a first sleeve part and a second sleeve part, which can be fixedly connected to one another. This facilitates favorable production of the spring sleeve and favorable production of the spring accommodating region in one of the sleeve parts, which can be closed with the other sleeve part. As an alternative, one part of the spring accommodating region can be formed in the sleeve parts such that the spring accommodating region is completely formed when the spring sleeve is joined together. Advantageously, the spring accommodating region can be located outside of the parting plane of the at least two sleeve parts such that the spring accommodating region is formed in the main body, which is closed by a cover. Such an asymmetrical division into the main body and the cover results in diverse and low-cost design possibilities using primary-forming, non-cutting, or even metal-cutting production methods. The spring accommodating region can be embodied with a great deal of design freedom. Likewise, the sleeve parts can be easily positioned relative to one another and joined to one another.

According to a further aspect of the present invention, an electrical contact element is proposed, in particular for a medical implant for introduction into the human or animal body, comprising:
a spring sleeve having a connector bore for receiving an electrical mating contact in an insertion direction, wherein the spring sleeve comprises at least one spring accommodating region, which is disposed around the connector bore, at least in regions, and is open, at least in regions, toward the connector bore; and
at least one spring element, which is disposed in the spring accommodating region, for the electrical contacting of the electrical mating contact in an inserted state of the mating contact. It is provided that, when the mating contact is not inserted, the spring accommodating region has an open space into which the spring element deflects when the mating contact is inserted into the connector bore.

Medical implants within the meaning of the present invention are, in particular, active implantable medical devices, for example, cardiac pacemakers, electrical neurostimulators, and the like.

Given that an open space is provided in the spring accommodating region, the spring element can be stretched and subjected to tensile stress when the mating contact is inserted such that the spring element rests against the mating contact via multiple contacts, in a favorable and stable manner. Advantageously, the spring element can designed with an elongated shape, in particular as a wire spiral. Advantageously, the spring sleeve can have a channel section in the spring accommodating region for each of the spring ends of the elongated spring element. The spring accommodating region advantageously has a curved section, which is partially disposed around the connector bore, and has channels extending away therefrom. The spring accommodating region is designed such that the spring element can form the largest possible wraparound angle on the mating contact, preferably at least 180°, and offers sufficient open space toward the outside for the spring element so that the spring effect and/or the spring deformation can be applied. The spring accommodating region is designed such that the spring element, in the unloaded state thereof, i.e., without the mating contact inserted, can engage into the connector bore. When a mating contact is not present, the spring element has an inner diameter in the curved section that is smaller than the outer diameter of the mating contact, stretches when the mating contact is inserted, and can deflect radially outward into the open space of the spring accommodating region around the connector bore.

According to a favorable embodiment, the spring element can be fixed on the spring sleeve such that the spring element becomes a tension spring upon deflection into the open space. Both the spring element and the spring sleeve can therefore be produced with advantageous tolerances, since the requirements that must be met for an exact-fit adaptation of the spring sleeve, the spring accommodating region, and the spring element are less as compared to an exclusively radially acting support of the spring element.

The spring element can be designed as a spring coil, in the case of which a wire is wound so as to form a spiral. The wire can have any cross-section, for example, round, polygonal, star-shaped, etc., in order to improve the contact resistance to the mating contact. Advantageously, the spring element can be made of a suitable, in particular biocompatible, material that has sufficiently good spring properties. A few non-limiting examples of such materials are iron-based alloys, e.g. 316, titanium alloys, e.g. TiAl6V4, nonferrous alloys, e.g. MP35N, or platinum alloys, e.g. PtIr and other platinum alloys having special spring properties that contain at least one element from the group palladium, copper, molybdenum, tungsten, niobium, and tantalum.

Platinum alloys having spring properties that are particularly suitable for this intended use are known from German Patent No. 37 12 839, for example. These platinum alloys, which have great hardness and good deformability, retain their spring properties even after being influenced by heat, e.g., due to welding or soldering.

It is also conceivable to use a core material in the interior of the spring element that has good spring properties and is provided with a coating having good biocompatibility and good electrical conductivity, such as, for example, a spring steel or MP35N as the core material having a coating of Pt, PtIr, Au, Pd or the like. MP35N is a curable alloy based on nickel-cobalt.

In this regard, the coating can have spring properties that are adequate for the application and/or can have an electrical conductivity that is adequate for the application. The coating can be applied chemically, electrochemically, physically—e.g. by plating or cold welding—in one or more layers.

It is advantageous when the spring elements and/or spring sleeves are designed to be biocompatible. Since these are not in direct contact with the body, however, biocompatibility is not an indispensible property. It is particularly advantageous when the spring elements and/or spring sleeves are designed to be stable against corrosion and/or electrochemical loading in the environment of bodily fluids, e.g. blood, and/or are provided with a corresponding coating.

Expediently, the material can have spring properties that are adequate for the particular application and can have an electrical conductivity that is adequate for the particular application.

Furthermore, a material that can be annealed into a shape can be used to produce shaped spring elements, such as, for example, MP35N. The shaped spring element can already have a shape that is adapted to the spring accommodating region, which results in advantages for the insertion of the shaped spring element into the spring sleeve and for the function as a spring contact element.

The spring element is used as an electrical contact surface, at least at the regions of the spring accommodating region that are open toward the connector bore, for the mating contact that is inserted into the connector bore, and rests against the mating contact with spring force. Expediently, the spring accommodating region is located at a constant axial level relative to the longitudinal axis of the connector bore. It is also conceivable that the spring accommodating region can have a slope. Advantageously, the spring accommodating region can be U-shaped in design.

Advantageously, the channels can be disposed at a slant or perpendicular to the curved section of the spring accommodating region. It is thereby possible for the spring element to wrap around a large portion of an inserted mating contact and form a large contact surface.

When a mating contact is not inserted, the spring element can protrude at least partially into the connector bore, thereby ensuring a secure contacting of the mating contact via the generation of tensile stress in the spring element.

In this regard, it is provided in an expedient embodiment that, when the mating contact is not inserted, the spring element has an inner diameter in the region of the curved section that is smaller than an outer diameter of the mating contact according to the present invention. The difference in the diameter can be small and the inner diameter of the spring element can be slightly smaller than the outer diameter of the mating contact.

Particularly advantageously, the spring element can be designed as a tensile loop such that, when the mating contact is inserted, said tensile loop wraps around this mating contact by 180° on the outer circumference thereof. It is thereby possible to achieve stable electrical contacting between the spring element and the mating contact. A round spring element is also conceivable, which lies in the curved section of the spring accommodating region of the spring sleeve, wherein the round spring element can lie loosely therein or, e.g. can be fixed at one or more points of the spring sleeve.

In one embodiment, the free end of the spring element can be placed in the one channel of the spring accommodating region and can be routed around the circumference of the spring sleeve through a second channel, which extends parallel to the first channel, in order to establish an at least partially wraparound spring contact. The spring element can also be an incompletely closed toroidal spring element, which can be routed, for example, in the first channel of the U-shaped spring accommodating region, the curved section, and in an additional, further channel that is tangential to the curved section, and out of the curved section. This second channel can be routed approximately parallel to the first channel, for example.

According to a favorable embodiment, the spring element can be fixedly connected to the spring sleeve at at least one point. Advantageously, both spring ends can be fixedly connected to the spring sleeve. As a result, a defined tensile stress can be generated when the spring element undergoes a defined deflection. Advantageously, the spring element can be welded to the spring sleeve, e.g. in the region of the channel of the spring accommodating region. In particular, the spring element can be laser-welded to the spring sleeve, which permits particularly good placement of the welding point.

A contact device can comprise, e.g. a plurality of such contact elements having spring sleeves and spring elements arranged in a row next to one another in an axial direction, wherein the circumferential curved sections of the respective spring accommodating regions are disposed concentrically to one another, preferably parallel to one another, such that a mating contact having contact regions, which are electrically insulated from one another, can come into contact with the respective spring elements of the respective spring sleeves.

In a further favorable embodiment, the spring element can comprise one or both of the channels of the spring accommodating region. The protruding end of the spring element can be used for the electrical contacting of the spring sleeve itself. As an alternative, the spring element can terminate flush with the channel and can electrically contact the spring sleeve at another point.

According to a favorable embodiment, the spring sleeve can be designed to comprise two parts or multiple parts. The spring element can be easily installed as a result. It is favorable to provide the spring accommodating region in one part of the spring sleeve and another part of the spring sleeve as a simply shaped cover. Due to the divided spring sleeve, it is furthermore possible to design the curved section and the channels of the spring accommodating region in a largely free manner and according to need, for the purpose of which primary-forming, non-cutting, or even metal-cutting methods can be used. In addition, the parts of the spring sleeve can be positioned relative to one another in an uncomplicated manner and can be fixedly connected to one another in a low-cost manner.

Advantageously, the spring accommodating region can be located within a parting plane of the two-part or multiple-part spring sleeve. The cross-section of the spring sleeve can be selected to have any shape, such as round, square, etc. The spring element can be placed into the spring accommodating region, fastened on the spring sleeve, in particular in the region of the channels of the spring accommodating region, and can be closed with the cover.

Advantageously, the spring element can be a wire spiral. This offers particularly numerous contact points when in the contact with the mating contact. The wire spiral can be produced similarly to helixes for cardiac pacemaker electrode leads, i.e. such a spiral can be wound out of a wire or a plurality of individual wires and can be prefabricated in relatively long units of length. This enables the spring element to be produced in a particularly cost-effective manner.

Furthermore, a method for producing a contact element is proposed, wherein a spring element having a desired length is placed into a spring accommodating region of a spring sleeve and is fixedly connected to the spring sleeve, and the spring accommodating region is closed with a sleeve part of the spring sleeve. This enables a contact element to be produced in a cost-effective manner.

Favorably, the spring element can be annealed into a shape in order to obtain a shape similar to that of the spring accommodating region.

Particularly advantageously, a contact force of the spring element can be preset by inserting a test mating contact into the connector bore and, with the test mating contact inserted, the spring element is acted upon with a defined tensile force and, in this state, is fixedly connected to the spring sleeve and, optionally, is trimmed off.

Advantageously, the spring element can be a wire spiral. Such wire spirals can be produced in long lengths and can be cut to fit.

Advantageously, costs can be reduced by using a production process that is highly automatable. The wire spiral can extend directly out of the winding process, via a guide element and through a passage channel, into the groove of the spring sleeve.

The inserted spring element can be used as a wiring element and can be automatically welded to the spring sleeve at one point and can be trimmed to the proper length. As an alternative, the spring element can be welded with the spring sleeve so as to be flush therewith, and can be trimmed to fit.

Further embodiments, features, aspects, objects, advantages, and possible applications of the present invention could be learned from the following description, in combination with the Figures, and the appended claims.

### DESCRIPTION OF THE DRAWINGS

The present invention is explained in the following in greater detail, as an example, with reference to exemplary embodiments that are depicted in drawings. In schematic depictions:

FIG. 1 shows a schematic depiction of a contact device having contact elements according to a first embodiment of the present invention.

FIG. 2 shows a view of a first embodiment of a spring sleeve having channels of a spring accommodating region in a spring sleeve, said channels extending toward a curved section.

FIG. 3 shows a section of the spring sleeve from FIG. 2.

FIG. 4 shows a top view of a first embodiment of a spring accommodating region in a spring sleeve.

FIG. 5 shows a top view of a further embodiment of a spring accommodating region in a spring sleeve.

FIG. 6 shows a top view of a further embodiment of a spring accommodating region in a spring sleeve.

FIG. 7 shows a partially cut-away spring sleeve having a spring element inserted into a spring accommodating region.

FIGS. 8A-8B show a schematic depiction of an electrical contact surface of a mating contact that is in contact with a spring sleeve.

FIG. 9 shows a favorable embodiment of a spring sleeve having one spring element.

FIG. 10 shows a favorable embodiment of a spring sleeve having two spring elements.

FIG. 11 shows a favorable embodiment of a spring sleeve having three spring elements.

FIGS. 12A-12C show examples of elongated wire spirals.

FIGS. 13A-13C show examples of annular wire spirals from FIGS. 12A-12C.

### DETAILED DESCRIPTION

Elements that are functionally identical or similar-acting are labeled using the same reference symbols in the Figures. The figures are schematic depictions of the present invention. They do not depict specific parameters of the present invention. Furthermore, the Figures merely show typical embodiments of the present invention and are not intended to limit the present invention to the embodiments shown and discussed herein.

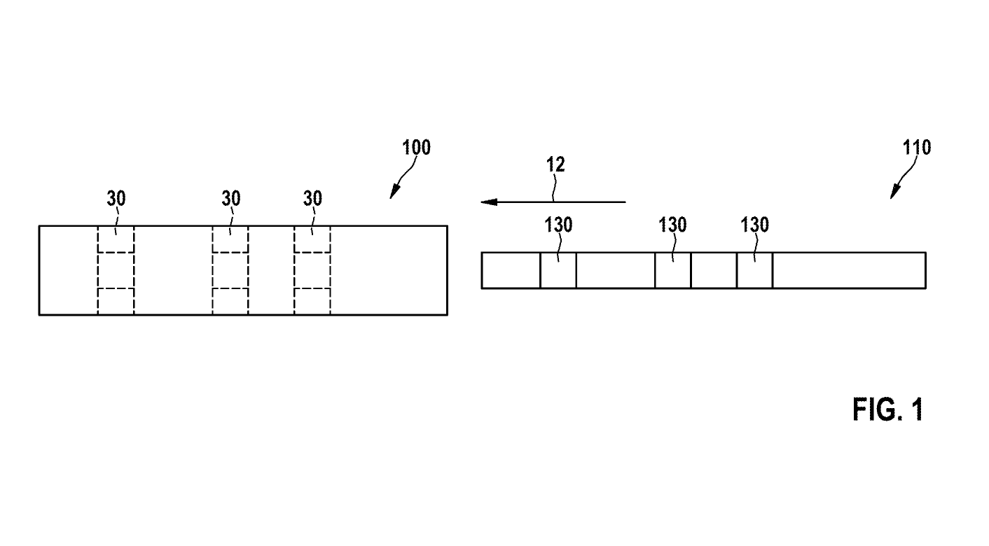

FIG. 1 shows a schematic view of an embodiment of a contact device 100 having several, for example three, electrical contact elements 30. The details of a medical implant, in particular an active medical device, with which the contact device 100 and an electrical mating contact 110 allocated thereto are coupled, namely, details such as connected components, electrical components and the like, are not depicted, as these are understood by one of ordinary skill in the art.

The electrical mating contact 110, for example a pin, is provided for insertion into the contact device 100 in the direction 12 of a longitudinal axis. In so doing, the electrical mating contact 110 is routed through the contact elements 30. The electrical mating contact 110 comprises, on the outer side thereof, several, for example three, contact surfaces 130, which come into contact with the contact elements 30 when the electrical mating contact 110 is inserted into the contact device 100.

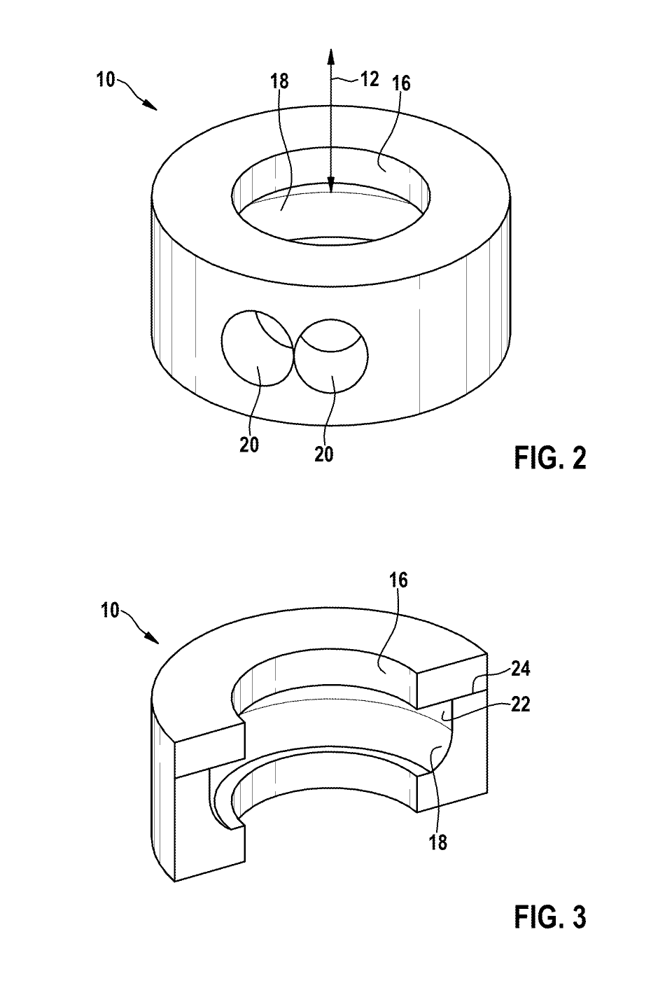

FIGS. 2-3 show, for the purpose of explaining the present invention, an isometric view of a spring sleeve 10 of a contact element 30 (see FIG. 1) and a section through the spring sleeve 10 of a first embodiment having a connector bore 16 for receiving an electrical mating contact (not illustrated) in an insertion device 12.

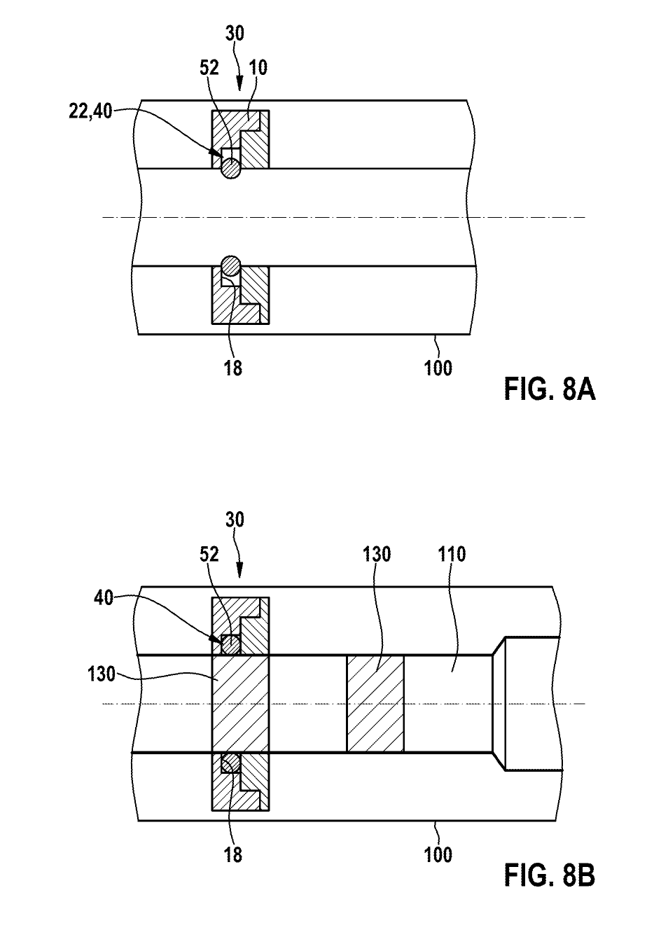

The spring sleeve 10 has a spring accommodating region 40. A curved section 18 of the spring accommodating region 40, which extends around the connector bore 16 and is open toward the connector bore 16, is disposed around the connector bore 16, which extends in the axial direction 12, said curved section lying in a plane transverse to the direction 12. The curved section 18 is provided to accommodate a spring element 52 (see FIGS. 7, 8A-8B) in order to electrically contact the electrical mating contact (not illustrated). The spring sleeve 10, together with the spring element 52 (see FIGS. 7, 8A-8B), forms the insertion element 30 (see FIG. 1).

Two channels 20 of the spring accommodating region 40 are disposed transversely to the peripheral curved section 18 in the spring sleeve 10 for insertion of the spring element 52 (see FIGS. 7, 8A-8B) into the wraparound groove 18. The channels 20 extend approximately parallel from the outer side of the spring sleeve 10 toward the curved section 18 and are disposed in the same plane as the curved section 18. The curved section 18 can have a profile that is prismatic (polygonal), for example. The curved section 18 and the channels 20 form the spring accommodating region 40 of the spring sleeve 10.

One channel 20 of a non-closed spring element 52 (see FIGS. 7, 8A-8B) is provided for spring end, said channel extending from an outer side of the spring sleeve 10 to at least one curved section 18, wherein, when the mating contact 110 is not inserted, the curved section 18 has a radial open space 22 into which the spring element 52 (see FIGS. 7, 8A-8B) can deflect when the mating contact 110 is inserted (see FIGS. 8A-8B). As a result, a tension spring function of the spring element 52 can be implemented, wherein said spring element can be expanded by an inserted mating contact and can deflect into the open space 22 of the curved section 18. Due to the open space 22, the curved section 18 does not need to provide radially outward support for the spring element 52 when the mating contact is not inserted, but rather loosely accommodates said spring element. Advantageously, the spring element 52 (see FIGS. 7, 8A-8B) can be designed as a wire spiral.

In the embodiment depicted here, the spring sleeve 10 comprises two parts. The spring sleeve 10 is separated in the plane 24 transverse to the direction 12 and extends outside (above, in the Figure) of the plane of the spring accommodating region 40. Said spring accommodating region is covered by joining the two parts of the spring sleeve 10. Due to the two-part design thereof, the spring sleeve 10 can be produced at low cost and, therefore, particularly cost-effectively by means of primary-shaping processes such as injection-molding or casting. Other production processes are also conceivable. The spring element can be placed into the spring accommodating region 40 of one part of the spring sleeve 10 and fixed thereon, for example, by means of laser welding. The first part can then be closed with the second part of the spring sleeve 10.

The spring sleeve 10 is cylindrical, for example, although it can also have other cross-sections. The contact device 100 (FIG. 1) can also comprise a plurality of such spring sleeves 10, which are disposed in succession, concentrically to the axis of symmetry and in the direction 12 (not illustrated).

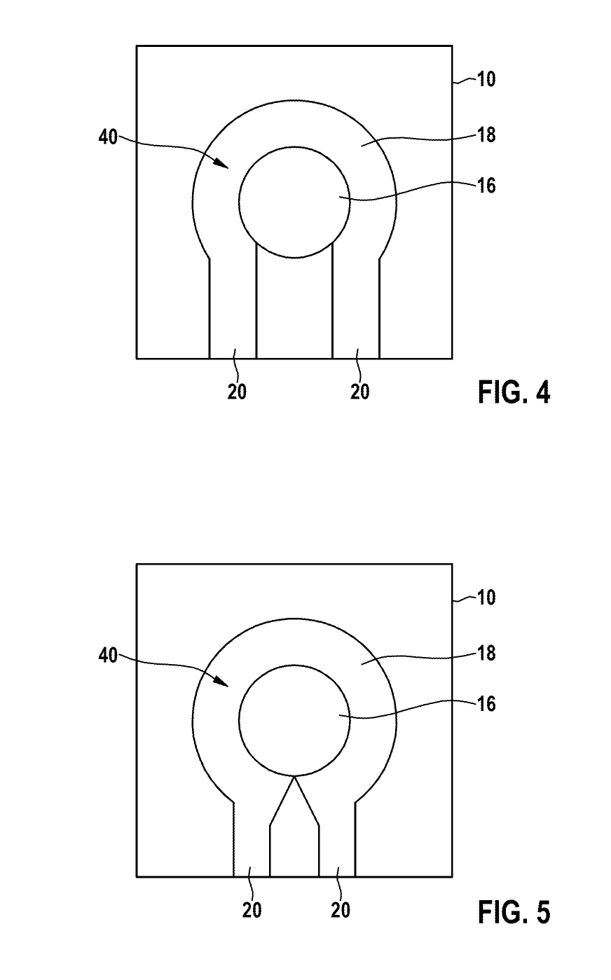

FIGS. 4-6 show top views of various embodiments of the spring accommodating region 40 of a spring sleeve 10. In the embodiments, the spring sleeve 10 has a square cross-section, for example, although it can have a different cross-section as necessary. An inserted spring element (not illustrated) protrudes into the connector bore 16, at least in regions, and is expanded by an inserted mating contact and is pressed radially outward in the curved section 18 of the spring accommodating region 40.

The spring sleeves 10 in the Figures are similarly designed and, therefore, only the differences between the embodiments will be addressed in order to avoid unnecessary repetitions.

FIG. 4 shows an embodiment having a curved section 18, toward which the two channels 20 extend in an approximately tangential manner. In the top view, the cross-section of the spring accommodating region 40 is approximately U-shaped such that a spring element inserted therein (not illustrated) encloses the connector bore 16 and, therefore, an inserted mating contact (not illustrated), as a tensile loop.

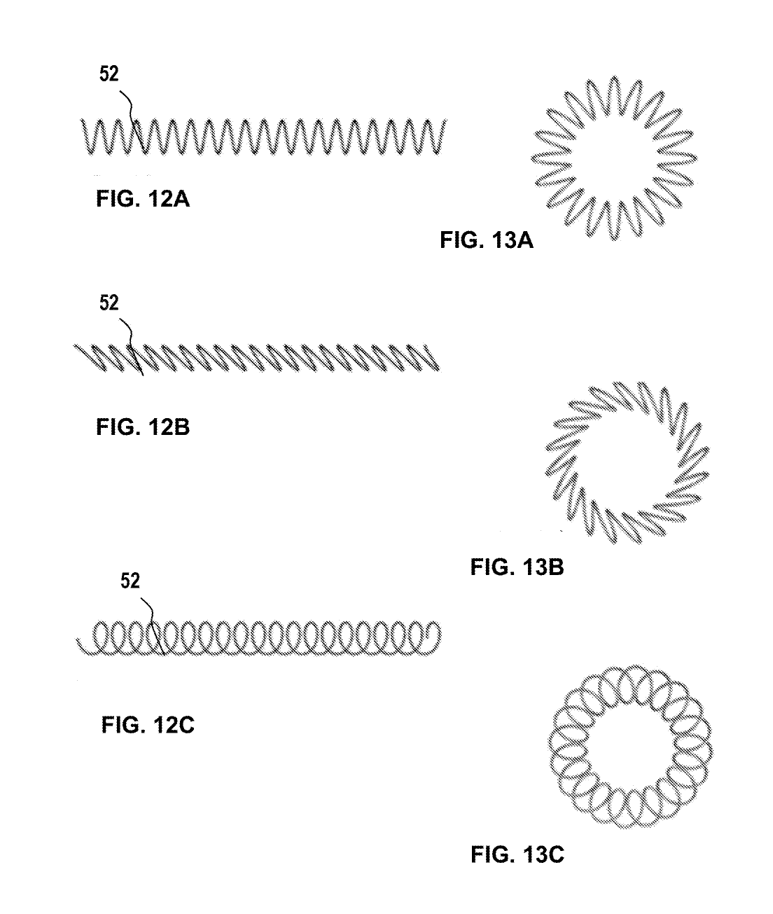

An inserted spring element, for example in the form of an originally elongated wire spiral section (as depicted, for example, in FIGS. 12A-12C), extends with one spring end into one of the two channels 20, wraps around a part of the connector bore 16 in the curved section 18 and extends with the other spring end thereof into the other of the two channels 20. The U-shape of the spring accommodating region makes it possible for a contact force of the spring element to be applied by means of a tension spring in the form of a loop and not by means of radially acting spring elements. A wraparound angle of the spring element relative to the mating contact results that is approximately 180°.

In at least one of the channels 20, preferably in both, the spring element is fixed on the spring sleeve 10, for example with a welding point. Due to the open space in the curved section 18, the wire spiral does not need to be slanted, but rather can be radially wound in the usual manner, since the wire spiral is tensioned by means of the special design of the spring sleeve. Due to the fixed connection of the spring element to the spring sleeve 10, an electrical contact to the spring sleeve 10 is also established.

In order to produce the spring coil, it is not necessary to maintain a particular orientation during the installation of the spring element (see FIGS. 12A-13A), as is the case with the slanted spring elements (see FIGS. 12B-13C). This has the further advantage that the spring ends can remain open, since said spring ends can be connected to the spring sleeve, in particular being welded thereto, in no particular orientation relative to one another.

FIG. 5 shows a top view of a further embodiment of a spring accommodating region 40 in a spring sleeve 10, in which the spring accommodating region 40 is designed such that a larger wraparound region of an inserted mating contact is possible for a spring element inserted therein. In this case, the two channels 20 extending parallel to one another no longer extend toward the curved section 18 in an approximately tangential manner, as shown in FIG. 4, but rather in an approximately radial manner. A wraparound angle of an inserted spring element relative to the mating contact results that is approximately 180°. An inserted spring element likewise functions as a tensile loop, as in FIG. 4.

In the embodiments depicted in FIGS. 4 and 5, the curved section 18 is designed in each case to be concentric about the connector bore 16. The embodiments are particularly suited for spring elements that are annealed into a shape and, due to the annealing into a shape, already have a U-shape corresponding to the spring accommodating region 40. The inner diameter of the curved part of the spring element is slightly smaller in this case than the outer diameter of the mating contact.

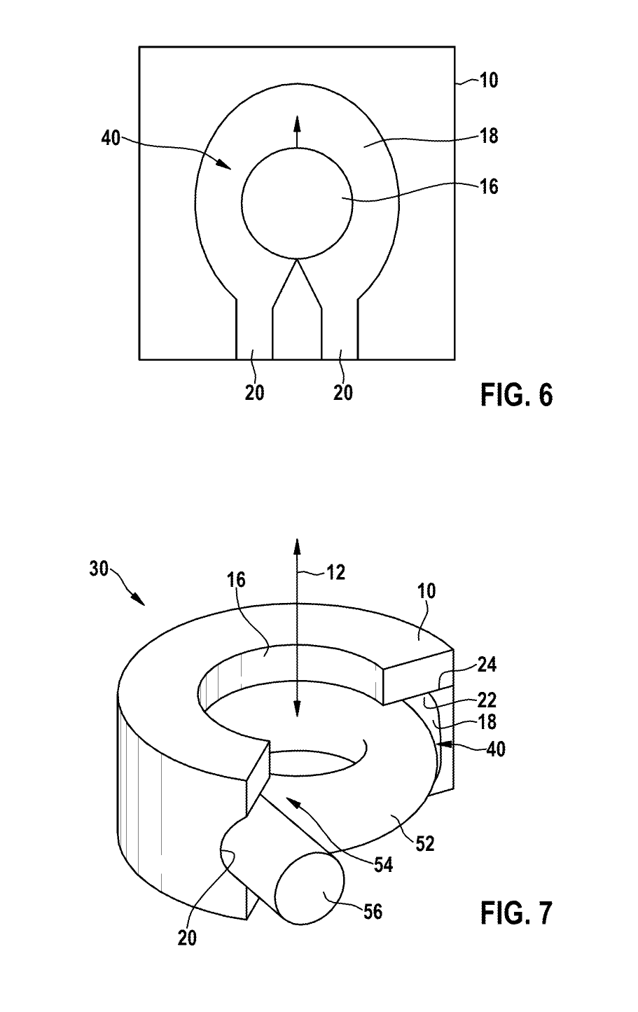

FIG. 6 shows a top view of a further embodiment of a spring accommodating region 40—which is formed of a curved section 18 and two channels 20—in a spring sleeve 10, which largely corresponds to the spring accommodating region 40 in FIG. 5. In contrast thereto, the curved section 18 is disposed eccentrically relative to the connector bore 16. Such an embodiment is favorable for spring elements that are not annealed into a shape and can therefore deflect in a preferred radial direction (upward in the Figure, as indicated by the arrow) when a mating contact is inserted. The spring accommodating region 40 guides the spring element such that said spring element protrudes, via the inherent curvature thereof in the curved section 18 in the unloaded state, into the connector bore 16 for the mating contact and can function with outward spring action when the mating contact is inserted.

FIG. 7 shows an alternative embodiment having a partially cut-away spring sleeve 10 and a spring element 52, which is inserted into a spring accommodating region 40 having only one channel 20, which extends to the curved section 18. The curved section 18 is disposed so as to concentrically encircle a connector bore 16. If an electrical mating contact, e.g. a pin (not illustrated), is inserted into the connector bore 16 in direction 12, said mating contact comes into contact with the spring element 52, and an electrical connection is established between the spring element 52 and the mating contact. In order to fix the position thereof, the spring element 52 is fixedly connected, e.g. welded, to the spring sleeve 10 at at least one point. When the mating contact is inserted, the spring element 52 expands and deflects radially outward into the open space 22 of the curved section 18.

The spring element 52 is placed into the spring accommodating region 40 of the spring sleeve 10 so far that a leading free end of the spring element 52 impacts a trailing region of the spring element 52. In the embodiment shown, the spring element 52 protrudes from the channel 20 and can be used as a connection for an electrical contacting of the spring sleeve 10. As an alternative, the spring element 52 can terminate flush with the channel 20 (not illustrated).

FIGS. 8A-8B illustrate the effect of the spring elements 52 as a tension spring by reference to a section of a contact device 100, in which a contact element 30 having a spring sleeve 10 and spring element 52 is inserted. FIG. 8A shows the situation with a mating contact. FIG. 8B shows the contact device 100 with the inserted mating contact 110 having electrical contact surfaces 130. Advantageously, the spring element can be designed as a spring coil.

The spring element 52 lies in the spring accommodating region 40 of the spring sleeve 10 and, in the unloaded state without the mating contact 110 inserted, protrudes into the connector bore 16 of the spring sleeve 10. An open space 22 is available radially in the groove 18 around the spring element such that the spring element 52 is not supported on the outside by the groove 18.

If the mating contact 110 is inserted, said mating contact displaces the spring element 52 radially outward, since the outer diameter of the mating contact 110 is slightly larger than the inner diameter of the spring element 52. The spring element 52 can deflect radially outward into the open space 22 and thereby acts on the mating contact as a tension spring.

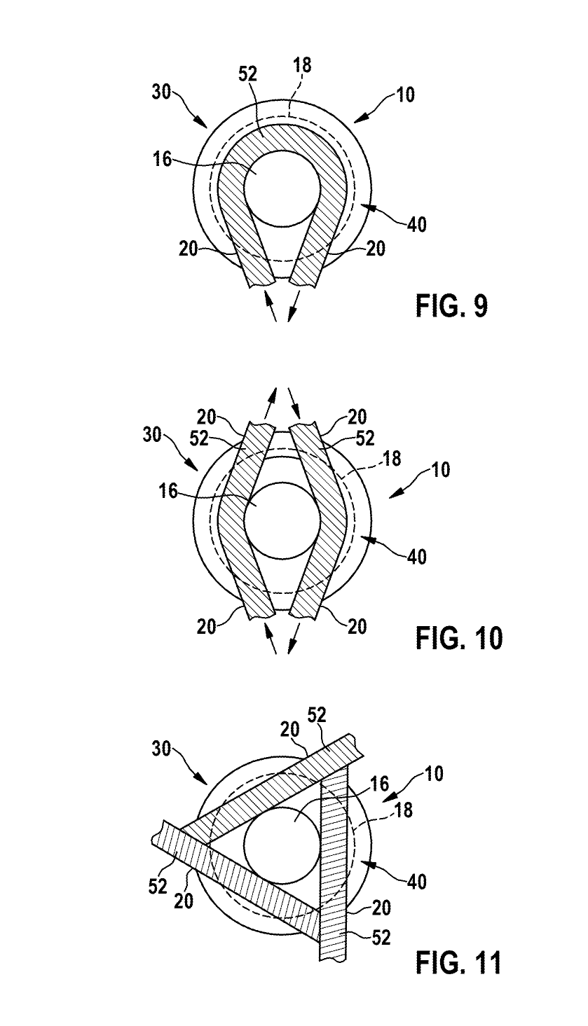

FIGS. 9 and 10-11 illustrate, as examples, favorable further alternative embodiments of a contact element 30 comprising a spring accommodating region 40 having a plurality of channels 20 in the spring sleeve 10, said channels being used to accommodate a multi-part spring element 52.

FIG. 9 shows two channels 20, which lie next to one another and extend toward one another at a slant, wherein the two ends of the spring element 52 protrude from said channels. The spring element 52 can be trimmed to fit accordingly and is preferably fixed on the spring sleeve 10, as described above. The spring element 52 largely encircles the connector bore 16.

FIG. 10 shows a favorable embodiment of a contact element 30 having two sections of two spring elements 52 extending there through, wherein said sections which can protrude, via the free ends thereof, out of the channels 20, more or less further out of the spring sleeve 10, on both sides of the spring sleeve 10. The spring element 52 can be trimmed to fit accordingly and is preferably fixed on the spring sleeve 10, as described above. The two spring elements 52 do not encircle the connector bore 16 or an electrical mating contact, but rather contact an electrical contact surface of a mating contact on two diametrically opposed sides.

FIG. 11 shows a favorable embodiment of a contact element 30 having three spring elements 52, which are disposed around the connector bore 16 so as to be offset by 120° and which are inserted or placed into the spring sleeve 10 tangentially and substantially in the extended form through separate channels 20 of the spring accommodating region 40. Due to a suitable open space in the groove 18 or the spring accommodating region of the spring sleeve 10, the spring element 52 or the spring elements 52 can deflect radially outward into the open space when the mating contact is inserted into the connector bore 16 and acts or act on the mating contact as a tension spring.

FIGS. 12A-12C show examples of elongated wire spirals for spring elements 52. FIGS. 13A-13C show annular wire spirals, as examples.

In order to install the spring elements 52 in the spring sleeves, it is not necessary to maintain a particular orientation of the spring element 52 (see FIGS. 12A-13A), as is the case with the slanted spring elements (see FIGS. 12B-13C).

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range.

I/We claim:

1. A spring sleeve for an electrical contact element for a medical implant, comprising:
a connector bore for receiving an electrical mating contact in an insertion direction; and
at least one spring accommodating region, which is disposed around the connector bore, at least in regions, and is open, at least in regions, toward the connector bore, said spring accommodating region being provided to receive a spring element for the electrical contacting of the electrical mating contact,
wherein an open space in the spring accommodating region such that a properly inserted spring element can deflect into the open space when the mating contact is inserted.

2. The spring sleeve according to claim 1, wherein the spring accommodating region is substantially U-shaped in design and has a curved section and channels extending away from the curved section.

3. The spring sleeve according to claim 1, wherein the spring sleeve comprises an at least two-part design having a first sleeve part and a second sleeve part, which can be fixedly connected to one another.

4. The spring sleeve according to claim 3, wherein the spring accommodating region lies outside of a parting plane of the at least two sleeve parts.

5. An electrical contact element for a medical implant, comprising:
a spring sleeve having a connector bore for receiving an electrical mating contact in an insertion direction, wherein the spring sleeve comprises at least one spring accommodating region, which is disposed around the connector bore, at least in regions, and is open, at least in regions, toward the connector bore; and
at least one spring element, which is disposed in the spring accommodating region, for the electrical contacting of the electrical mating contact in an inserted state of the mating contact,
wherein when the mating contact is not inserted, the spring accommodating region has an open space around the connector bore, into which the spring element deflects when the mating contact is inserted into the connector bore.

6. The contact element according to claim 5, wherein the spring element is fixed on the spring sleeve such that the spring element becomes a tension spring upon deflection into the open space.

7. The contact element according to claim 5, wherein when the mating contact is not inserted, the spring element protrudes at least partially into the connector bore.

8. The contact element according to claim 5, wherein with the mating contact is inserted, the spring element wraps around said mating contact by at least 180° on the outer circumference thereof.

9. The contact element according to claim 5, wherein the spring element is a wire spiral.

10. The contact element according to claim 9, wherein the spring element is made of a corrosion-resistant and/or biocompatible material and/or is coated with a corrosion-resistant and/or biocompatible material.

11. A method for producing a contact element according to claim 5, comprising:
placing a spring element having a desired length into a spring accommodating region of a spring sleeve;
fixedly connecting the spring element to the spring sleeve; and
closing the spring accommodating region with a sleeve part of the spring sleeve.

12. The method according to claim 11, wherein the spring element is annealed into a shape in order to obtain a shape similar to that of the spring accommodating region.

13. The method according to claim 11, wherein the spring element in the spring sleeve is acted upon by a defined tensile force and, in the acted-upon state, is fixedly connected to the spring sleeve.
